(19) United States
(12) Patent Application Publication
(10) Pub. No.: US 2005/0191556 A1
(43) Pub. Date: Sep. 1, 2005

(54) Metal alloy-based negative electrode, method of manufacturing the same, and lithium secondary battery containing the metal alloy-based negative electrode

(75) Inventors: Ju-Yup Kim, Seoul (KR); Han-Su Kim, Seoul (KR); Myung-Dong Cho, Hwaseong-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/024,599

(22) Filed: Dec. 30, 2004

(30) Foreign Application Priority Data
Jan. 2, 2004 (KR) 10-2004-0000043

(51) Int. Cl. H01M 2/16; H01M 4/58

(52) U.S. Cl. 429/246; 429/137; 429/231.95; 429/253

(57) ABSTRACT

The present invention is related to a negative electrode for a lithium secondary battery, a method of manufacturing the same, and a lithium secondary battery containing the negative electrode. In particular, the negative electrode of the present invention has improved initial charge/discharge efficiency, and increased lifespan by limiting the swelling of a lithium alloy-based active material. The negative electrode comprises a negative active material layer, comprising a lithium alloy-based negative active material, formed on a current collector, where the surface of the negative active material layer is coated with a polymer film formed from a solution mixture of a crosslinking monomer with ionic conductivity and low electric conductivity, a polymer support, and an organic solvent, and the negative active material layer includes cavities filled with crosslinking monomers that are cross-linked with one another.

### CROSS-REFERENCE TO RELATED APPLICATIONS

This application claims priority to Korean Patent Application No. 2004-43, filed on Jan. 2, 2004, in the Korean Intellectual Property Office, the disclosure of which is incorporated herein in its entirety by reference.

### FIELD OF THE INVENTION

The present invention is related to a lithium alloy-based negative electrode, a method of manufacturing the same, and a lithium secondary battery containing the lithium alloy-based negative electrode. In particular, the lithium alloy-based negative electrode may be coated with a polymer film having ionic conductivity. The present invention is also related to a method of manufacturing the polymer film, and a lithium secondary battery containing the lithium alloy-based negative electrode.

### BACKGROUND

With the recent improvements to portable electronic devices, the demand for secondary batteries has increased. Further, portable electronic devices have become much lighter, thinner, and smaller in size, which results in the introduction of batteries with a high energy density, such as lithium secondary batteries. However, when metal lithium is used as a negative electrode material, many problems arise. For example, a decreased rapid charging capability, reduced cycle lifespan, dendrite growth, and ignition and explosion may occur. Specifically, the risk of ignition and explosion may cause safety concerns. In order to solve these problems, carbonaceous materials and/or graphitic materials have been used for the negative electrodes, and batteries containing the negative electrodes have been commercialized. However, graphite has a theoretical discharge capacity of 372 mAh/g, which is much lower than that of metal lithium (4000 mAh/g). Therefore, there is a need to develop a negative material containing a lithium alloy, which has a discharge capacity almost equal to that of the metal lithium.

A lithium alloy which may be used for the negative active materials may be, for example, a Li—Sn alloy, Li—Zn alloy, Li—Bi alloy, Li—Al alloy, Li—As alloy, Li—Si alloy, Li—Sb alloy, or the like. However, the negative active materials containing a lithium alloy swell significantly by intercalating/deintercalating of lithium. As a result, the active material and the electrode deteriorate mechanically, therefore impairing lifetime characteristics. In a lithium alloy-based negative electrode, the swelling results in an increased surface area of the electrode, which increases side reactions such as a solvent decomposition reaction in the electrolyte. In addition, the conductivity of the electrode decreases due to the decreased dimensional stability.

Further, during initial charging/discharging, the lithium alloy-based negative electrode exhibits a very poor initial charge/discharge efficiency compared with electrodes containing conventional graphitic active materials. In this case, an initially discharged amount divided by an initially charged amount multiplied by 100 denotes the initial charge/discharge efficiency (%). The initial efficiency of the lithium alloy-based active material may be low for many reasons. In particular, an increased side reaction such as a solvent decomposition reaction in the electrolyte, low dispersion characteristics of lithium, and defects in materials may occur. In this case, the reason that the number of side reactions increase lies in the increased surface area of an electrode due to swelling. In order to overcome these problems, Japanese Patent Nos. 2001-135303 and 2001-283848 disclose methods of coating a lithium alloy-based active material with a conductive polymer or carbon. However, in this case where a conductive coating exists, it is very difficult to prevent a solvent and a salt from irreversibly decomposing in an electrolyte.

Alternatively, Japanese Patent Laid-open Publication No. hei 7-235328 discloses a lithium secondary battery, where the surface of a carbonaceous negative electrode is uniformly coated with a solid polymer electrolyte. Here, a suspended phase dispersion is first prepared by mixing an organic solvent with a solid polymer electrolyte. Then, fine carbon powder is mixed and dispersed in the suspended phase dispersion. Therefore, the solid polymer electrolyte can be adsorbed onto the surface of the carbonaceous material.

Moreover, Japanese Patent Laid-open Publication No. hei 8-306353 discloses a lithium battery where the surface of a negative electrode mainly composed of a carbonaceous material is coated with a polymer film in order to suppress gas generation. In this case, the polymer film is prepared by mixing a polymer material and an alkali metal salt. However, the alkali metal salt penetrates into an inside of an electrode plate, thus reacting with a metal that composes a negative active material. In addition, some polymers, such as polyethylene oxide, are likely to be dissolved in an electrolyte after cross-linking, due to their own properties.

U.S. Pat. No. 5,658,685 discloses a lithium battery where a polymer gel electrolyte includes a blend polymer film. However, in this case, the swelling of the negative active material is not prevented. Korean Patent No. 1997-036527 discloses a lithium secondary battery containing trimethylolpropane triacrylate for an electrode composition to have a long lifespan of an electrode and improved ionic conductivity. However, in this case, a trimethylolpropane derivative and a hydrophilic polymer are only used as a binder of a composite electrode. That is, they are not used to prevent the swelling of a negative active material.

Therefore, in order to improve the initial charge/discharge efficiency by suppressing electrolytic decomposition reactions while improving dimensional stability of an electrode assembly during charging/discharging, the coating compound must have ionic conductivity and low electric conductivity, and also have high elasticity to reduce the risk of mechanical damage on an electrode assembly due to swelling.

### SUMMARY OF THE INVENTION

The present invention is directed to a negative electrode with high initial charge/discharge efficiency and an increased lifespan. In particular, these properties may be obtained by preventing the swelling of a lithium alloy-based negative active material. The present invention is also directed to a method of manufacturing the negative electrode, and a lithium secondary battery using the same.

In one aspect of the present invention, a solution mixture may be prepared by mixing a crosslinking monomer and a polymer support. The solution mixture may be used to form a crosslinked polymer film on a negative electrode surface of a lithium secondary battery. As a result, the number of decomposition reactions of a negative active material in electrolyte may be decreased and the risk of damage to an electrode assembly during charging/discharging may be reduced. Accordingly, the initial charge/discharge efficiency and the lifespan of a lithium secondary battery may be increased.

In another aspect of the present invention, a negative electrode comprising a negative active material layer may be formed on a current collector. Specifically, the negative active material layer may comprise a lithium alloy-based negative active material. The surface of the negative active material layer may be coated with a polymer film formed from a solution mixture of a crosslinking monomer with ionic conductivity and low electric conductivity, a polymer support, and an organic solvent. Furthermore, the negative active material layer may comprise cavities filled with crosslinking monomers that are cross-linked with one another.

A further aspect of the present invention is directed to methods of manufacturing a negative electrode for a lithium secondary battery. In particular, the method may be carried out in the following manner. A negative active material layer including a lithium alloy-based negative active material may be formed on a current collector; and the negative active material layer may be coated with a solution mixture of a crosslinking monomer with ionic conductivity and low electric conductivity, a polymer support, and an organic solvent, and then the coated negative active material layer may be allowed to harden to form a polymer film on the negative active material layer.

An additional aspect of the present invention is directed to a lithium secondary battery comprising a positive electrode having a current collector and a positive active material layer formed on the current collector, a negative electrode containing a current collector and a negative active material layer containing a lithium alloy formed on the current collector, and an electrolyte interposed between the positive electrode and the negative electrode. Furthermore, a polymer film may be formed on the negative active material layer using a solution mixture of a crosslinking monomer with ionic conductivity and low electric conductivity, a polymer support, and an organic solvent. Additionally, the negative active material layer may include cavities filled with crosslinking monomers that are crosslinked with one another.

According to the present invention, a polymer film may be coated on a negative active material to increase the adhesive forces between the current collector and the active material, and to suppress reactions between the electrolytic solution and the active material. As a result, risk of mechanical damage to the electrode assembly during charging/discharging can be limited, thereby improving the initial charge/discharge efficiency and lifespan of a lithium secondary battery.

### BRIEF DESCRIPTION OF THE DRAWINGS

FIG. 1 is a graph illustrating initial charge/discharge efficiency with respect to the molecular weight of PEGDMA, which is used as a crosslinking monomer according to the present invention.

FIG. 2 illustrates the cyclic characteristics of a lithium battery with respect to a crosslinking monomer according to the present invention.

FIG. 3 illustrates the charge efficiency with respect to a composition of a crosslinking monomer and a polymer support according to the present invention.

FIG. 4 is a graph illustrating the charge efficiency of lithium batteries according to Example 8 and Examples 11-13.

### DETAILED DESCRIPTION OF THE INVENTION

The present invention discloses a negative electrode for a lithium secondary battery which may comprise a negative active material layer formed on a current collector. In particular, the negative active material layer may comprise a lithium alloy-based negative active material where the surface of the negative active material layer may be coated with a polymer film. The polymer film may be formed from a solution mixture of a crosslinking monomer with ionic conductivity and low electric conductivity, a polymer support, and an organic solvent. Also, the negative active material layer may comprise cavities filled with crosslinking monomers that are cross-linked with one another.

The negative active material according to the present invention may comprise a lithium alloy. The lithium alloy may be formed by alloying lithium with a metal such as Sn, Al, Si, Bi, Zn, As, Sb, and Pb, for example. Specifically, the lithium alloy may be an Sn—Li alloy, an Al—Li alloy, a Si—Li alloy, or a Pb—Li alloy. More specifically, the lithium alloy may be Si—Li alloy or Sn—Li alloy. In the latter case, the content ratio of at least a metal of the above-described metals to lithium may be about 40:60.

In an embodiment of the present invention, any crosslinking monomers that comprise at least two double bonds and can be cross-linked when exposed to, e.g., heat or ultraviolet light may be used. In particular, a crosslinking monomer with ionic conductivity and low electric conductivity may be used. The crosslinking monomer may be one or more compounds which include, but are not limited to, acrylate, such as hexyl acrylate, butyl acrylate, trimethylolpropane triacrylate (TMPTA), diacrylate, or triacylate; dimethacrylate such as butandiol dimethacrylate, or trimethacrylate; diallyl ester such as diallylsuberate, or triallyl ester; ethyleneglycoldimethacrylate, tetraethylene dimethylacrylate (TTEGDA), or poly(ethyleneglycol)diacrylate (PEGDA), polyethyleneglycol dimethacrylate (PEGDMA); diglycidyl ester; acrylamide; and divinylbenzene.

In another embodiment, the amount of the crosslinking monomer may be in the range of about 5 parts to about 50 parts by weight and specifically, in the range of about 10 parts to about 30 parts by weight based on 100 parts by weight of the organic solvent. If the amount of the crosslinking monomer is less than about 5 parts by weight, the degree of crosslinking, when the cross linking occurs, may be too low to express the crosslinking characteristics, and thus the electrolyte-retaining ability and mechanical characteristics may deteriorate. However, if the amount of the crosslinking monomer is greater than about 50 parts by weight, the inner resistance an electrode plate may increase, which may result in decreased capacity during charging/discharging at high rates.

The molecular weight of the crosslinking monomer may be in the range of 200 to about 2000. If the molecular weight of the crosslinking monomer is smaller than about 200, the density of crosslinking point in a polymer structure may become too high to interrupt the flow of a lithium salt and a positive active material when the crosslinking is completed. However, if the molecular weight of the crosslinking monomer is greater than about 2000, the density of crosslinking point in a polymer may be too low to block an electrolytic solution when the crosslinking is completed.

In a further embodiment, the polymer support may one or more compounds such as polymethylmethacrylate (PMMA), polyacrylic acid (PAA), polymethacrylic acid (PMA), polyethylmethacrylate (PEMA), and propylene carbonate methacrylate (PCMA), for example. In particular, the polymer support may be PMMA.

The polymer support enhances adhesive forces between the negative active material and the current collector. In general, a binder that may be used in the manufacturing process of a negative electrode cannot maintain adhesive forces effectively because a lithium metal-based negative electrode swells significantly due to the electrolyte. Therefore, the polymer supporter is introduced with the crosslinking monomer after a negative active material layer is formed to increase the strength of adhesive forces. The latter method may also be used in the present invention. PMMA has strong adhesive forces and a low risk of swelling. However, PMMA does not mix well as a binder when forming the negative active material layer. Therefore, PMMA may be introduced as a polymer support with the crosslinking monomer when forming the polymer film.

In another embodiment, the amount of the polymer support may be in the range of about 0.5 parts to about 10 parts by weight and specifically in the range of about 1 part to about 5 parts by weight based on 100 parts by weight of the organic solvent. If the amount of the polymer support is less than about 0.5, adhesive forces on the inside of the electrode plate may decrease. However, if the amount of the polymer support is greater than about 10 parts by weight, the polymer support may act to interrupt the flow of the active material on the inside of the electrode plate.

The weight ratio of the crosslinking monomer to the polymer support may be in the range of about 9:1 to about 7:3. If the amount of the polymer support is relatively too low, the adhesive effect is not sufficient. If the amount of the polymer support is relatively too large, the polymer support may interrupt the flow of the active material during charging at high rates.

The mixture solution may further include an electrolyte. However, no use of an electrolyte is preferable.

The method of manufacturing the negative electrode according to the present invention may be carried out in the following manner. A negative active material layer comprising a lithium alloy-based negative active material may be formed on a current collector, and then the negative active material layer may be coated with a solution comprising a mixture of a crosslinking monomer with ionic conductivity and low electric conductivity, a polymer support, and an organic solvent, and then the coated negative active material layer may be allowed to harden in order to form a polymer film on the negative active material layer.

In a particular embodiment, a lithium alloy-based negative active material, a conductor, a binder, and a solvent may be mixed to prepare a negative active material composition. The negative active material composition may then be coated on a current collector to form a negative active material layer. Then, the negative active material layer may be coated with a solution mixture of a crosslinking monomer, a polymer support, and an organic solvent and then hardened to form a polymer film.

The polymer film may have a thickness in the range of about 0.5 μm to about 10 μm. If the thickness is smaller than about 0.5 μm, the film may be too thin to block the electrolytic solution. However, if the thickness is larger than about 10 μm, the thickness of the film may be too large to increase the interfacial resistance between an electrode and the electrolyte above a acceptable level. The polymer film may be formed by hardening using heat, pressure, UV, and high-energy radiation such as an electron beam, or a γray. Crosslinking polymerization using heat may be performed at a temperature in a range of about 50° C. to about-90° C. for a time period in the range of about 20 seconds to about 80 seconds.

Additional embodiments of the present invention are directed to a lithium secondary battery comprising a positive electrode having a current collector and a positive active material layer formed on the current collector; a negative electrode containing a current collector and a negative active material layer comprising a lithium alloy formed on the current collector; and an electrolyte interposed between the positive electrode and the negative electrode. Particularly, the polymer film may be formed on the negative active material layer using a mixture comprising a solution of a crosslinking monomer with ionic conductivity and low electric conductivity, a polymer support, and an organic solvent. Additionally, the negative active material layer may comprise cavities filled with crosslinking monomers that are crosslinked with one another.

An electrode active material layer may be formed by directly coating the current collector with an electrode active material composition. Alternatively, the electrode active composition may be coated on a separated support, and then dried to form a film. The resultant film may be detached from the separated support and then laminated on a current collector. In this case, any support that can support the active material layer can be used in the present invention. The support may be for example, a Myla film, or a polyethyleneterephthalate (PET) film. The current collector may be a foil, a mesh-type expanded metal, or punched metal, but is not limited thereto. The electrode active material composition may comprise an electrode active material, a conductor, a binder, and an organic solvent. A current collector for a negative electrode may be a metal film itself. Additionally, the positive active material may be a lithium composite oxide, or a sulfur compound, for example. Examples of the lithium composite oxide may include LiCoO₂, and LiMn₂O₄.

According to embodiments of the present invention, the conductor may be a carbon black or the like. Examples of the carbon black may include MCMB, MCF, super-P, and acetylene black. The amount of the conductor may be in the range of about 1 part to about 20 parts by weight based on 100 parts by weight of the electrode active material. In further embodiment, the binder may be, but is not limited to, vinylidene fluoride-hexafluoro-hexafluoropropylene copolymer (VDF/HFP copolymer), polyvinylidene fluoride, polyacrylonitrile, polymethylmethacrylate, or a combination thereof. The amount of the binder may be in the range of about 5 parts to about 30 parts by weight based on 100 parts by weight of the electrode active material.

Any solvent that is commonly used in lithium secondary batteries can be used in the present invention. The solvent may be acetone, N-methylpyrrolidone, or the like. The electrode active material composition may include Li₂CO₃, to improve the battery performance. In a specific embodiment, the addition of Li₂CO₃ may result in a slow decomposition reaction between the negative electrode plate and the electrolytic solution, and thereby reduce the risk of mechanical damage on an electrode assembly during charging/discharging. Therefore, the initial charge/discharge efficiency and the lifespan of the lithium secondary battery improve. In another embodiment, the electrolyte may comprise a lithium salt and an organic solvent. The organic solution may be one or more compounds such as benzene, fluorobenzene, toluene, trifluorotoluene (FT), xylene, cyclohexane, tetrahydrofuran (THF), 2-methyltetrahydrofuran (2-MeTHF), ethanol, isopropylalcohol (IPA), dimethylcarbonate (DMC), ethylenemethylenecarbonate (EMC), diethylcarbonate (DEC), methylpropylcarbonate (MPC), methylpropionate (MP), ethylpropionate (EP), methylacetate (MA), ethylacetate (EA), propylacetate (PA), dimethylester (DME), 1,3-dioxolane, digylme (DGM), tetragylme (TGM), ethylenecarbonate (EC), propylenecarbonate (PC), γ-butyrolactone (GBL), sulforane, dimethylsulfone, dialkylcarbonate, butyrolactone, N-methylpyrrolidone, tetramethylurea, glyme, ether, crownether, dimetoxyethane, hexamethylphosphoamide, pyridine, N,N-diethylacetamide, N-N-diethylformamide, dimethylsulfoxide, tetramethylurea, tributylphosphate, trimethylphosphate, tetramethylenediamine, tetramethylpropylenediamine, pentamethyldiethylenetriamine, trimethylphosphate, and tetramethylenediamine. Additionally, the lithium salt may be one or more compounds such as from LiPF₆, LiSO₃CF₃, LiN(SO₂CF₃)₂, LiClO₄, LiBF₄, and LiAsF₆, for example.

### EXAMPLES

### Specific Example 1

A Si—Li alloy as an active material, a carbon black as a conductor, and PVDF as a binder were dissolved in 10 g of NMP to prepare a negative active material slurry. The negative active material slurry was coated on a copper foil with a width of about 5.1 cm and a thickness of about 178 μm and then dried to form a negative active material layer.

In order to form a polymer film on the negative active material layer, PEGDMA dissolved in 10 g of DMC and 0.1 g of PMMA were mixed to form a polymer film forming composition. In this case, PEGDMA (molecular weight 330) was used as a crosslinking monomer, and PMMA was used as a polymer support. The polymer film forming composition was coated on the negative active material layer, and then hardened at about 80° C. for about 30 seconds in order to form a thin film having a thickness of in the range of about 3 μm to about 4 μm.

### Specific Example 2

A negative electrode was manufactured in the same manner as in Example 1, except that PEGDMA (molecular weight 550) was used as the crosslinking monomer.

### Specific Example 3

A negative electrode was manufactured in the same manner as in Example 1, except that PEGDMA (molecular weight 875) was used as the crosslinking monomer.

### Specific Example 4

A negative electrode was manufactured in the same manner as in Example 1, except that 1 g of tetraethyleneglycol dimethacrylate (TTEGDMA) was used as the crosslinking monomer.

### Specific Example 5

A negative electrode was manufactured in the same manner as in Example 1, except that 1 g of trimethylolpropane triacrylate (TMPTA) was used as the crosslinking monomer.

### Specific Example 6

94 g of LiCoO₂, 3 g of super-P, and 3 g of polyvinylidenefluoride (PVDF) were dissolved in N-methyl-2-pyrrolidone (NMP) to prepare a positive active material slurry. The positive active material slurry was coated on aluminum foil with a width of about 4.9 cm and a thickness of about 147 μm, and then dried in order to fabricate a positive electrode. The negative electrode manufactured in Example 1 and the positive electrode were placed in a case, and then impregnated with an electrolytic solution to completely form a lithium battery.

### Specific Examples 7-10

Lithium batteries were manufactured in the same manner as in Example 6, except that each of the negative electrodes manufactured in Examples 7-10 were used instead of the negative electrode manufactured in Example 1.

### Specific Example 11

A lithium battery was manufactured in the same manner as in Example 6 using a negative electrode. The negative electrode was manufactured in the same manner as in Example 1, except that the polymer film was not formed.

### Specific Example 12

A lithium battery was manufactured in the same manner as in Example 6 using a negative electrode. The negative electrode was manufactured in the same manner as in Example 3, except that the polymer support was not used.

### Specific Example 13

A lithium battery was manufactured in the same manner as in Example 6 using a negative electrode. The negative electrode was manufactured in the same manner as in Example 5, except that the polymer support was not used.

### Specific Example 14

Lithium batteries manufactured in Examples 6-8 were charged and then discharged only once at about 0.2° C. to measure the initial charge/discharge efficiency. The results are shown in FIG. 1. In comparison, the initial charge/discharge efficiency of the lithium battery manufactured in Example 11 was measured.

As shown in FIG. 1, the initial charge/discharge efficiency of a lithium secondary battery including a polymer film, formed on a negative active material layer, was superior to that of a lithium secondary battery in which the polymer film was not formed. In particular, the initial charge/discharge efficiency was greatest when the molecular weight of PEGDMA was about 875.

### Specific Example 15

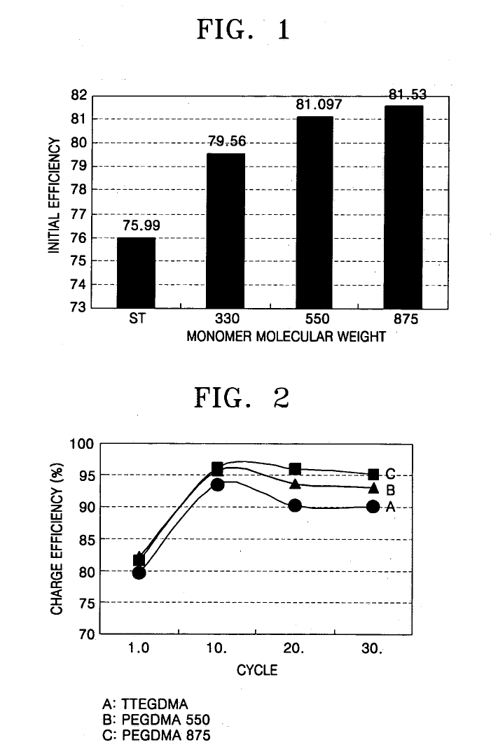

Lithium batteries manufactured Examples 7-9 were charged and discharged 10, 20, and 30 times at about 0.2° C. to measure the charge/discharge efficiency. The results are shown in FIG. 2.

As shown in FIG. 2, the lithium battery according to the present invention exhibited very high charge/discharge efficiency after cycling. The charge/discharge efficiency is was greatest when the molecular weight of PEGDMA was 875.

### Specific Example 16

The initial charge/discharge efficiency was measured while the amounts of a polymer support and a crosslinking monomer were varied. In this case, the polymer support and the crosslinking monomer were used to form a polymer film. PEGDMA, PMMA, and 1M LiPF₆ EC/DEC (3:7) were used as a crosslinking monomer, a polymer support, and an electrolyte, respectively.

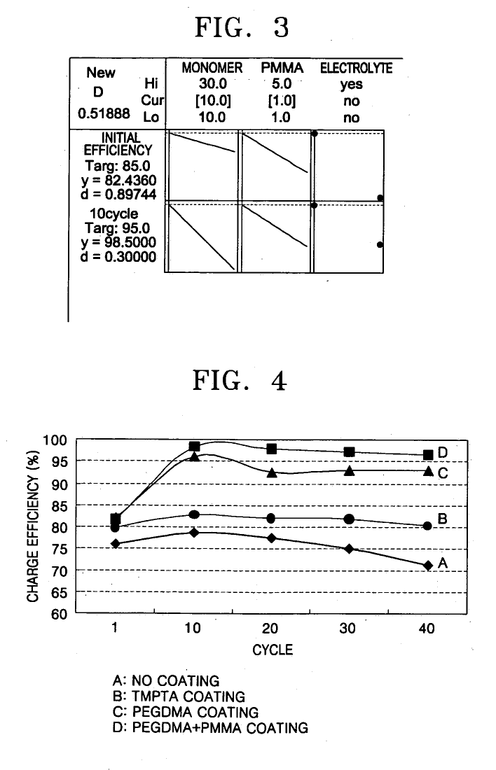

A lithium battery manufactured in the same manner as in Example 6 was used to measure the charge/discharge efficiency during the initial cycle and over 10 cycles. The results are shown in FIG. 3.

FIG. 3 illustrates the optimum composition of a crosslinking monomer and the polymer support. The optimum composition was found using a factorial design method of experimental designs methods. As shown in FIG. 3, the initial charge/discharge efficiency was excellent when no electrolyte, 10% of a crosslinking monomer, and 1% of a polymer support were used.

### Specific Example 17

The present experiment was carried out to determine if the use of a polymer supporter produces effects in addition to a crosslinking monomer. Lithium batteries according to Example 8 and Examples 11-13 were used to measure the charge/discharge efficiency with respect to cycling. The results are shown in FIG. 4.

As shown in FIG. 4, the charge/discharge efficiency was higher when the polymer film was formed on the negative active layer than when the polymer film was not formed. Further, the charge/discharge efficiency was the greatest when the polymer film was formed by mixing both the crosslinking monomer and a polymer support.

A negative electrode according to the present invention has a high initial charge/discharge efficiency and longer lifespan, compared with that containing an existing lithium alloy electrode. In addition, the negative electrode can be protected from swelling because the negative electrode is coated.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A negative electrode, comprising:
a negative active material layer formed on a current collector,
wherein the negative active material layer comprises a lithium alloy-based negative active material, and
wherein a surface of the negative active material layer is coated with a polymer film formed from a solution comprising a mixture of a crosslinking monomer with ionic conductivity and low electric conductivity, a polymer support, and an organic solvent, and
wherein the negative active material layer comprises cavities filled with crosslinking monomers that are cross-linked with one another.

2. The negative electrode of claim 1, wherein the lithium alloy is formed by alloying lithium with an element selected from the group consisting of Sn, Al, As, Bi, Si, Pb, Zn, and Sb.

3. The negative electrode of claim 1, wherein the crosslinking monomer is one or more compounds selected from the group consisting of hexyl acrylate, butyl acrylate, trimethylolpropane triacrylate, butandiol dimethacrylate, diallylsuberate, ethyleneglycol dimethacrylate, tetraethylene dimethylacrylate (TTEGDA), poly(ethyleneglycol)diacrylate (PEGDA), polyethyleneglycol dimethacrylate (PEGDMA), diglycidyl ester, acrylamide, and divinylbenzene.

4. The negative electrode of claim 1, wherein the solution mixture further contains an electrolyte.

5. The negative electrode of claim 1, wherein the amount of the crosslinking monomer is in the range of about 10 parts to about 50 parts by weight based on 100 parts by weight of the organic solvent.

6. The negative electrode of claim 1, wherein the molecular weight of the crosslinking monomer is in the range of about 200 to about 2000.

7. The negative electrode of claim 1, wherein the polymer support is one or more compounds selected from the group consisting of polymethylmethacrylate (PMMA), polyacrylic acid (PAA), polymethacrylic acid (PMA), polyethylmethacrylate (PEMA), and propylene carbonate methacrylate (PCMA).

8. The negative electrode of claim 1, wherein the amount of the polymer support is in the range of about 0.5 parts to about 10 parts based on 100 parts by weight of the organic solvent.

9. The negative electrode of claim 1, wherein the content ratio of the crosslinking monomer to the polymer support is in the range of about 9:1 to about 7:3.

10. A method of manufacturing a negative electrode for a lithium secondary battery, comprising:
forming a negative active material layer comprising a lithium alloy-based negative active material on a current collector; and
coating the negative active material layer with a solution mixture of a crosslinking monomer with ionic conductivity and low electric conductivity, a polymer support, and an organic solvent, and
hardening the coated negative active material layer to form a polymer film on the negative active material layer.

11. The method of claim 10, wherein the solution mixture is hardened by using heat, pressure, or irradiating an UV beam, an electron beam, or a γray.

12. The method of claim 11, wherein the hardening by heat is performed by crosslinking at a temperature in the range of about 50° C. to about 90□ for a time period in the range of about 20 seconds to about 80 seconds.

13. A lithium secondary battery, comprising:
a positive electrode comprising a current collector and a positive active material layer formed on the current collector;
a negative electrode comprising a current collector and a negative active material layer comprising a lithium alloy formed on the current collector; and
an electrolyte interposed between the positive electrode and the negative electrode,
wherein a polymer film is formed on the negative active material layer using a solution comprising a mixture of a crosslinking monomer with ionic conductivity and low electric conductivity, a polymer support, and an organic solvent, and
wherein the negative active material layer comprises cavities filled with crosslinking monomers that are crosslinked with one another.

14. The lithium secondary battery of claim 13, wherein the polymer film has a thickness of in the range of about 0.5 μm to about 10 μm.

15. The lithium secondary battery of claim 13, wherein the lithium alloy is formed by alloying lithium with an element selected from the group consisting of Sn, Al, Bi, Bs, Si, Pb, Zn, and Sb.

16. The lithium secondary battery of claim 13, wherein the crosslinking monomer is one or more compounds selected from the group consisting of hexyl acrylate, butyl acrylate, trimethylolpropane triacrylate (TMPTA), butandiol dimethacrylate, diallysuberate, ethyleneglycoldimethacrylate, tetraethylene dimethylacrylate (TTEGDA), poly(ethyleneglycol) diacrylate (PEGDA), polyethyleneglycol dimethacrylate (PEGDMA), diglycidyl ester, acrylamide, and divinylbenzene.

17. The lithium secondary battery of claim 13, wherein the polymer support is one or more compounds selected from the group consisting of polymethylmethacrylate (PMMA), polyacrylic acid (PAA), polymethacrylic acid (PMA), polyethylmethacrylate (PEMA), and propylene carbonate methacrylate (PCMA).

18. The lithium secondary battery of claim 13, wherein the weight ratio of the crosslinking monomer to the polymer support is in the range of about 9:1 to about 7:3.
